(19) United States
(12) Patent Application Publication
(10) Pub. No.: US 2015/0308449 A1
(43) Pub. Date: Oct. 29, 2015

(54) GAS TURBINE ENGINE COMPONENT WITH BRAZED COVER

(71) Applicant: UNITED TECHNOLOGIES CORPORATION, Hartford, CT (US)

(72) Inventor: Edward R. BAREISS, Stafford Springs, CT (US)

(21) Appl. No.: 14/624,697

(22) Filed: Feb. 18, 2015

Related U.S. Application Data
(60) Provisional application No. 61/950,869, filed on Mar. 11, 2014.

(51) Int. Cl. F04D 29/38; B23K 1/00

(52) U.S. Cl. CPC F04D 29/384; F04D 29/38; F04D 29/388; B23K 1/0018

(57) ABSTRACT

A component according to an exemplary aspect of the present disclosure includes, among other things, a body comprised of a first material, a cover attached to the body and comprised of a second material, and a braze alloy employable to braze the cover to the body and comprised of a third material. The first material, the second material and the third material are different materials.

### CROSS-REFERENCE TO RELATED APPLICATION

This application claims priority to U.S. Provisional Application No. 61/950,869 which was filed on Mar. 11, 2014.

### BACKGROUND

This disclosure relates to a gas turbine engine, and more particularly to a gas turbine engine component, such as a blade, that includes a brazed cover.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads. The compressor section and turbine section typically employ alternating rows of rotating blades and stationary vanes that drive the hot combustion gases along a core flow path. Blades and vanes are typically cast structures and may include internal cooling passages depending on their location within the engine.

A casting core may be used to form an internal cooling passage inside of the component during a casting operation. The casting core must be properly positioned inside the casting and may include surfaces that extend through the cast part, thereby creating openings or holes at undesirable locations once the core has been removed after casting. These openings must be sealed in order to close-off the internal cooling passage. One common technique for sealing the openings includes welding. However, welding operations generally create extreme local heat inputs that can lead to cracking in the part being welded.

### SUMMARY

A component according to an exemplary aspect of the present disclosure includes, among other things, a body comprised of a first material, a cover attached to the body and comprised of a second material, and a braze alloy employable to braze the cover to the body and comprised of a third material. The first material, the second material and the third material are different materials.

In a further non-limiting embodiment of the foregoing component, an internal cooling passage extends inside the body, the internal cooling passage coated with an internal coating.

In a further non-limiting embodiment of either of the foregoing components, the first material is a nickel-based superalloy.

In a further non-limiting embodiment of any of the foregoing components, the second material is Hastelloy-X.

In a further non-limiting embodiment of any of the foregoing components, the third material is AMS 4777.

A blade for a gas turbine engine according to another exemplary aspect of the present disclosure includes, among other things, an airfoil that extends to a tip shroud. The airfoil includes a cooling passage. A cover is attached to the tip shroud and covers the cooling passage, and a braze alloy is applied around the cover to braze the cover to the tip shroud. The airfoil, the cover and the braze alloy each include different material compositions.

In a further non-limiting embodiment of the foregoing blade, the cover is positioned and configured to adapt relative to an uneven surface of the tip shroud.

In a further non-limiting embodiment of either of the foregoing blades, the airfoil is made of a nickel-based superalloy.

In a further non-limiting embodiment of any of the foregoing blades, the cover is made of a nickel-based alloy.

In a further non-limiting embodiment of any of the foregoing blades, the braze alloy is made of a nickel-based compound.

In a further non-limiting embodiment of any of the foregoing blades, the airfoil is made of a rhenium-free, nickel-based superalloy.

In a further non-limiting embodiment of any of the foregoing blades, the cover is made of Hastelloy-X.

In a further non-limiting embodiment of any of the foregoing blades, the braze alloy is made of AMS 4777.

In a further non-limiting embodiment of any of the foregoing blades, the airfoil includes an internal aluminide coating.

In a further non-limiting embodiment of any of the foregoing blades, the cover includes a thickness of about 0.010 inches (0.254 mm)

A gas turbine engine method according to another exemplary aspect of the present disclosure includes, among other things, brazing a cover to a blade using a braze alloy. The cover, the blade and the braze alloy each comprise different material compositions.

In a further non-limiting embodiment of the foregoing gas turbine engine method, prior to the brazing step the gas turbine engine method includes casting the blade, positioning the cover relative to blade and applying the braze alloy around the cover.

In a further non-limiting embodiment of either of the foregoing gas turbine engine methods, prior to the brazing step, the gas turbine engine method includes applying an internal coating to an internal cooling passage of the blade, positioning the cover over at least one opening in a tip shroud of the blade and applying the braze alloy around the cover.

In a further non-limiting embodiment of any of the foregoing gas turbine engine methods, prior to the brazing step, the method includes positioning the cover at an uneven surface of a tip shroud of the blade and adapting the cover to conform to the uneven surface.

In a further non-limiting embodiment of any of the foregoing gas turbine engine methods, the gas turbine engine method is a repair method for repairing a part having a defect.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIG. 2 illustrates a gas turbine engine component.

FIG. 3 illustrates the gas turbine engine component of FIG. 2 prior to removal of a casting core.

FIG. 4 illustrates a top view of the gas turbine engine component of FIG. 2.

FIGS. 5A, 5B and 5C illustrate a blade of a gas turbine engine.

FIG. 5D illustrates a cover that may be brazed to a gas turbine engine component.

FIG. 6 schematically illustrates a gas turbine engine manufacturing method.

FIG. 7 schematically illustrates a gas turbine engine repair method.

### DETAILED DESCRIPTION

This disclosure is directed to a gas turbine engine component, such as a turbine blade, that includes an airfoil, a cover attached to a tip shroud of the airfoil, and a braze alloy used to affix the cover to the tip shroud. The airfoil, the cover and the braze alloy may each include different material compositions. In one embodiment, the airfoil, the cover and the braze alloy are made from different nickel-based alloys. By brazing the cover, extreme local heat inputs and associated thermal stresses are substantially removed, thereby reducing part susceptibility to cracking. These and other features are discussed in greater detail herein.

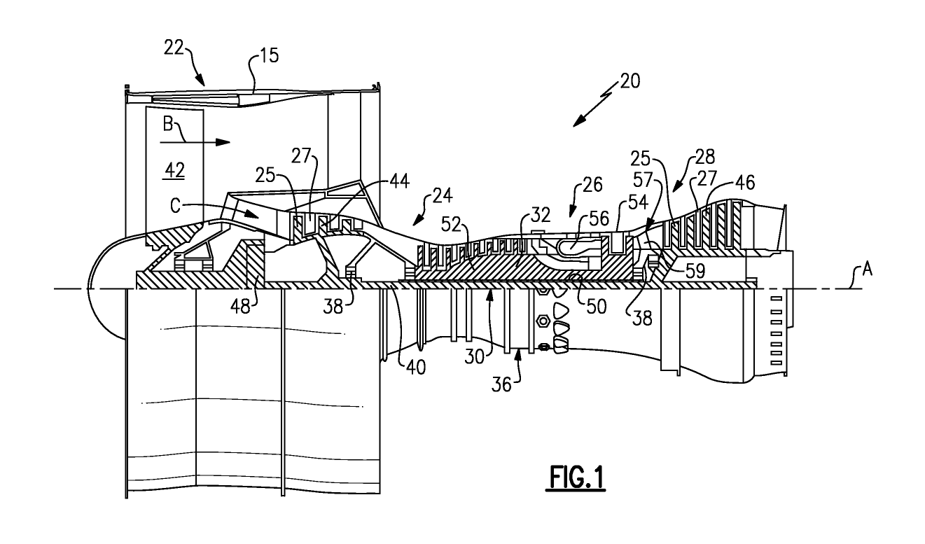

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmenter section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. For example, the teachings of this disclosure also extend to ground-based gas turbine engines.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of the bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via the bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The gear system 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram° R)/(518.7° R)]^{0.5}. The “Low corrected fan tip speed” as disclosed herein according to one non-limiting embodiment is less than about 1,150 ft/second (350.5 meters/second).

Each of the compressor section 24 and the turbine section 28 may include alternating rows of rotor assemblies and vane assemblies (shown schematically). For example, the rotor assemblies can carry a plurality of rotating blades 25, while each vane assembly can carry a plurality of vanes 27 that extend into the core flow path C. The blades 25 may either create or extract energy in the form of pressure from the core airflow as it is communicated along the core flow path C. The vanes 27 direct the core airflow to the blades 25 to either add or extract energy.

FIGS. 2, 3 and 4 illustrate a gas turbine engine component (hereinafter “component”) 60. The non-limiting embodiment depicted by FIGS. 2, 3 and 4 illustrate the component 60 as a blade, such as a turbine blade. It should be understood, however, that this disclosure is not limited to blades.

The component 60 may include a body 62 that defines both an external shape and an internal shape of the component 60. In one non-limiting embodiment, the body 62 includes an airfoil 64, a platform 66 and a root 68. The airfoil 64 extends outwardly in a first direct from the platform 66, and the root 68 extends from the platform 66 in an opposed, second direction away from the airfoil 64. The root 68 is adapted for connecting the component 60 to a rotating disk of a rotor assembly (not shown).

The airfoil 64 may extend between the platform 66 and a tip shroud 70. The tip shroud 70 is positioned at a tip 71 of the airfoil 64 and includes an outer diameter surface 74 that faces away from the platform 66. The tip shroud 70 may include rails 72 that project radially outwardly from the outer diameter surface 74. The rails 72 define knife seals that interface relative to a stationary engine structure (not shown) that may circumscribe the component 60.

In one non-limiting embodiment, the component 60 is a cast part and includes an internal cooling passage 76 (shown in phantom in FIG. 2) that extends inside of the body 62. For example, the internal cooling passage 76 may extend at least partially inside of the airfoil 64. In one non-limiting embodiment, the internal cooling passage 76 is a serpentine cooling passage. The internal cooling passage 76 may be formed during a casting process, such as an investment casting process, using a casting core 78 (shown in phantom lines in FIG. 3). The casting core 78 is removed from FIG. 2 in order to better illustrate the configuration of the internal cooling passage 76. The casting core 78 could include a ceramic core, a refractory metal core or a combined ceramic/refractory metal core.

As best illustrated in FIG. 3, the casting core 78 may include one or more print-out posts 79 that protrude through the outer diameter surface 74 of the tip shroud 70. The print-out posts 79 aid in positioning the casting core 78, setting the wall thickness of the airfoil 64, and preventing breakage of the cast part during the casting operation.

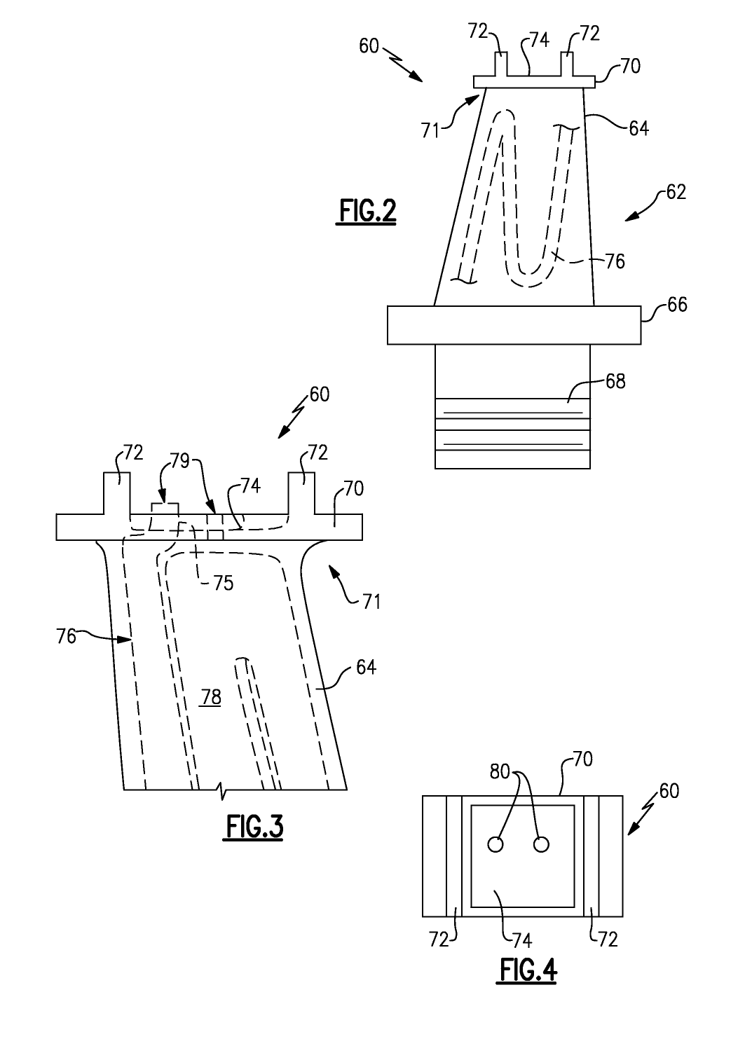

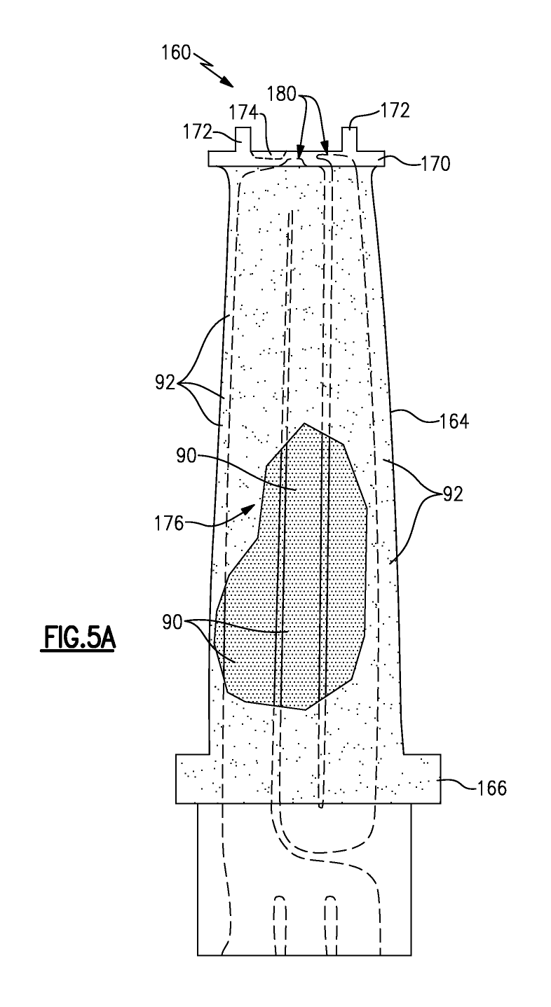

Referring now to FIGS. 3 and 4, removal of the casting core 78, including the print-out posts 79, subsequent to a casting operation may form one or more openings 80 (e.g., holes) at the outer diameter surface 74 of the tip shroud 70. The openings 80 must be sealed against the ingress or egress of airflow in order to close-off the internal cooling passage 76 so it can function to cool the component 60. Exemplary configurations for achieving such sealing are discussed in additional detail below.

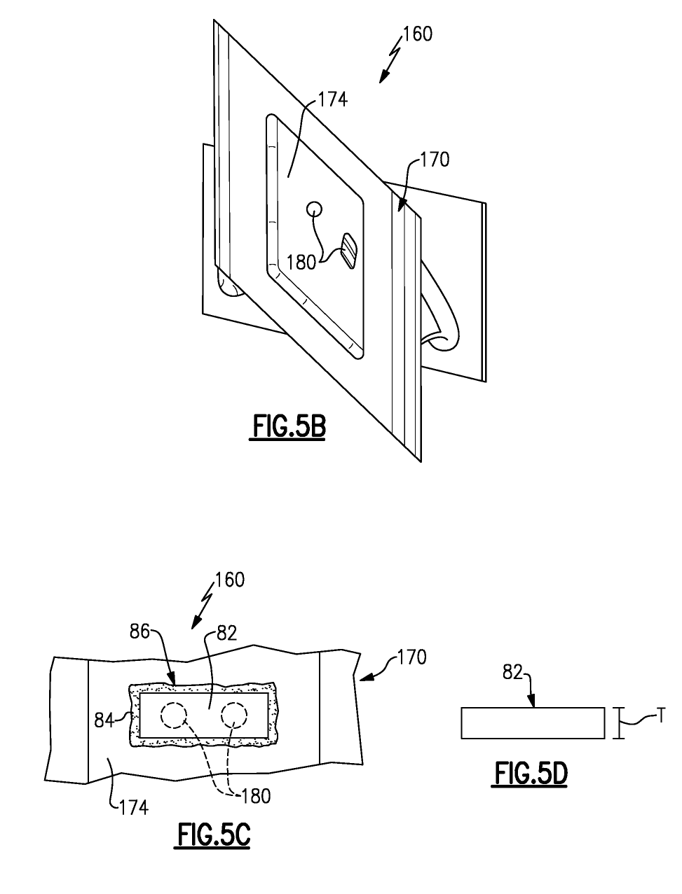

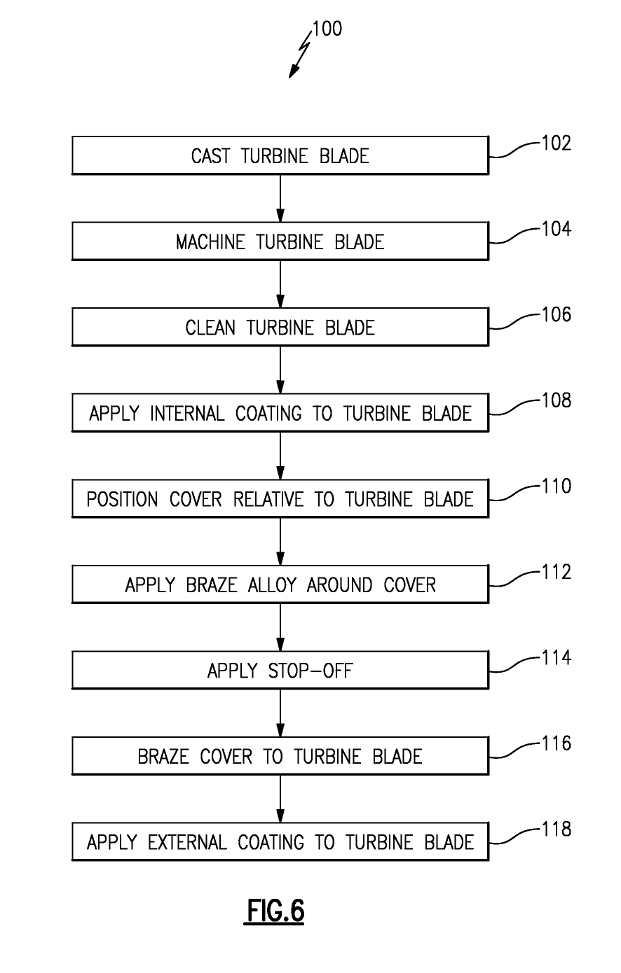

FIGS. 5A and 5B illustrate a turbine blade 160. The turbine blade 160 may employed within a turbine section of a gas turbine engine, including but not limited to, within a low pressure turbine, a high pressure turbine or any intermediate turbine.

The exemplary turbine blade 160 includes an airfoil 164 that extends between a platform 166 and a tip shroud 170. The tip shroud 170 defines an outer diameter surface 174 that faces away from the platform 166. Rails 172 may extend radially outwardly from the outer diameter surface 174. One or more openings 180 may be formed in the outer diameter surface 174. The openings 180 are formed in a finished casting after a casting core has been removed from the casting.

Referring to FIG. 5C, with continued reference to FIGS. 5A and 5B, a cover 82 may be attached to the outer diameter surface 174 of the tip shroud 170 in order to seal the openings 180. In this embodiment, the cover 82 is positioned to cover and seal two openings 180. However, the cover 82 may seal one or more openings 180. Although only a single cover 82 is illustrated in FIG. 4, multiple covers could be utilized to seal a component that includes a multitude of openings.

The cover 82 may include a thickness T (see FIG. 5D) of approximately 0.010 inches (0.254 mm), with a tolerance of +/−0.002 inches (0.051 mm). The relatively thin thickness T enables the cover 82 to conform to irregular surfaces during assembly. In one embodiment, the cover 82 may be positioned over an uneven surface 86 of the outer diameter surface 174 of the tip shroud 170 during assembly. The exemplary cover 82 may also provide weight benefits and net “pull” (i.e., centrifugal load stress) reductions.

The turbine blade 160 may additionally include a braze alloy 84. In one embodiment, the cover 82 is brazed to the tip shroud 170 using the braze alloy 84.

Each of the airfoil 164, the cover 82 and the braze alloy 84 may include different material compositions. For example, the airfoil 164 may be made of a nickel-based superalloy (i.e., a first material). One non-limiting embodiment of a suitable nickel-based superalloy includes a rhenium-free, investment cast, nickel-based superalloy.

The cover 82 may be made of a sheet metal form of a nickel-based alloy (i.e., a second material). One non-limiting embodiment of a suitable nickel-based alloy is Hastelloy-x.

The braze alloy 84 may be made of a nickel-based compound (i.e, a third material). One non-limiting embodiment of a suitable nickel-based compound includes AMS 4777.

The turbine blade 160 may additionally include an internal cooling passage 176 for internally cooling the part (see FIG. 5A). In one non-limiting embodiment, the internal walls of the turbine blade 160 that circumscribe the internal cooling passage 176 are coated with an internal coating 90. The internal coating 90 provides corrosion protection. One non-limiting embodiment of a suitable internal coating 90 is an aluminide coating.

In another embodiment, the external walls of the turbine blade 160 are coated with an external coating 92. The external coating 92 provides oxidation protection. Suitable external coatings include aluminide coatings or diffused overlay/sprayed coatings.

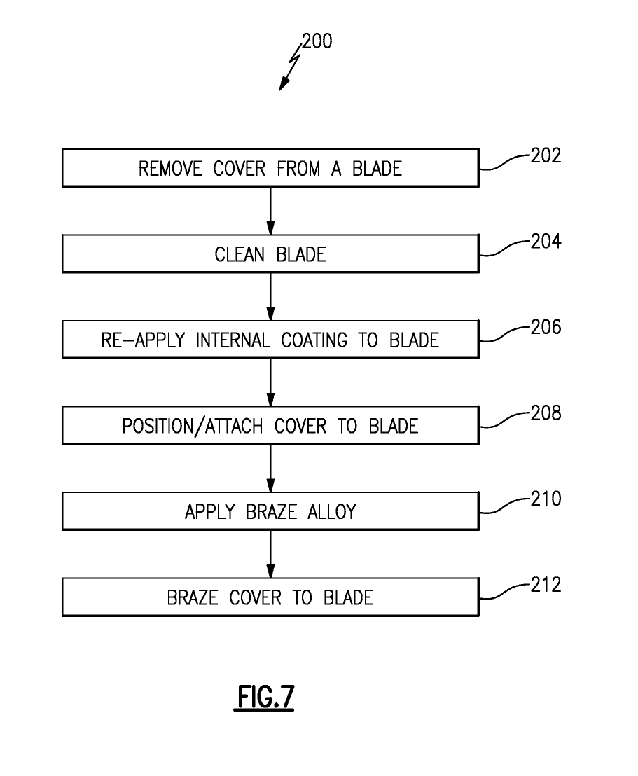

FIG. 6, with continued reference to FIGS. 5A-5D, schematically illustrates a gas turbine engine manufacturing method 100. The method may begin at block 102 by casting the turbine blade 160. Of course, this disclosure is not limited to manufacturing a turbine blade. The turbine blade 160 may be investment cast using a casting core to form the internal cooling passage 176 inside the airfoil 164. The turbine blade 160 may optionally undergo machining operations at block 104.

Next, at block 106, the turbine blade 160 is cleaned. In one non-limiting cleaning procedure, the turbine blade 160 is furnace cleaned for thirty minutes at 1300° F. (704° C.). The turbine blade 160 may additionally be silicon carbide blasted and degreased. Other cleaning techniques are also contemplated.

An internal coating, such as an aluminide coating, may be applied to the internal cooling passage 176 of the turbine blade 160 at block 108. The internal coating may be applied using openings 180 formed at the outer diameter surface 174 of the tip shroud 170.

The cover 82 is positioned relative to the turbine blade 160 at block 110. In one non-limiting embodiment, the cover 82 is tack-welded to the outer diameter surface 174 of the tip shroud 170 of the turbine blade 160 to attach the cover 82. The cover 82 may conceal one or more openings 80 formed through the outer diameter surface 174 during the casting process of block 102.

Next, at block 112, the braze alloy 84 may be applied around the edges of the cover 82. The braze alloy 84 may be applied as a slurry or a paste, in one embodiment. Alternatively, the cover 82 could be pre-alloyed using a sintering process, thereby eliminating the need apply the braze alloy 84 around the cover 82.

Stop-off may be applied around the cover 82 and the braze alloy 84 at block 114. The stop-off is applied to prevent undesired flow of the braze alloy 84 away from the cover 82.

At block 116, the cover 82 is brazed to the outer diameter surface 174 of the tip shroud 170. In one non-limiting embodiment, the turbine blade 160 is vacuum furnace brazed at approximately 1925° F. (1052° C.) for around fourteen minutes to braze the cover 82 to the turbine blade 160. Finally, at block 118, an external coating may be applied to the turbine blade 160. The turbine blade 160 could then be subjected to an additional furnace operation.

FIG. 7 illustrates a gas turbine engine repair method 200. The method 200 may be employed to repair a turbine blade 160 that has been damaged or otherwise includes a defect. First, at block 202, the cover 82 is removed from the blade 160. Removal of the cover 82 may expose openings 80 in an outer diameter surface 174 of the tip shroud 170. Exemplary removal operations include electrical discharge machining (EDM), hand-blending, milling, grinding or other operations.

Next, at block 204, the blade 160 is cleaned. An internal cooling passage 176 of the blade 160 may be recoated at block 206. The internal coating may include an aluminide coating, in one non-limiting embodiment.

A new cover 82 may next be positioned and/or attached to the tip shroud at block 208. The braze alloy 84 may be applied around the cover 82 at block 210, such as in the form of a slurry or paste. A pre-sintered cover 82 may alternatively be used. Finally, the cover 82 may be brazed to the tip shroud 170 of the blade 160 at block 212.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A component, comprising:
a body comprised of a first material;
a cover attached to said body and comprised of a second material; and
a braze alloy employable to braze said cover to said body and comprised of a third material, wherein said first material, said second material and said third material are different materials.

2. The component as recited in claim 1, comprising an internal cooling passage that extends inside said body, said internal cooling passage coated with an internal coating.

3. The component as recited in claim 1, wherein said first material is a nickel-based superalloy.

4. The component as recited in claim 1, wherein said second material is Hastelloy-X.

5. The component as recited in claim 1, wherein said third material is AMS 4777.

6. A blade for a gas turbine engine, comprising:
an airfoil that extends to a tip shroud, said airfoil including a cooling passage;
a cover attached to said tip shroud and covering said cooling passage; and
a braze alloy applied around said cover to braze said cover to said tip shroud, wherein said airfoil, said cover and said braze alloy each include different material compositions.

7. The blade as recited in claim 6, wherein said cover is positioned and configured to adapt relative to an uneven surface of said tip shroud.

8. The blade as recited in claim 6, wherein said airfoil is made of a nickel-based superalloy.

9. The blade as recited in claim 6, wherein said cover is made of a nickel-based alloy.

10. The blade as recited in claim 6, wherein said braze alloy is made of a nickel-based compound.

11. The blade as recited in claim 6, wherein said airfoil is made of a rhenium-free, nickel-based superalloy.

12. The blade as recited in claim 6, wherein said cover is made of Hastelloy-X.

13. The blade as recited in claim 6, wherein said braze alloy is made of AMS 4777.

14. The blade as recited in claim 6, wherein said airfoil includes an internal aluminide coating.

15. The blade as recited in claim 6, wherein said cover includes a thickness of about 0.010 inches (0.254 mm).

16. A gas turbine engine method, comprising:
brazing a cover to a blade using a braze alloy, wherein the cover, the blade and the braze alloy each comprise different material compositions.

17. The gas turbine engine method as recited in claim 16, wherein prior to the brazing step the gas turbine engine method includes:
casting the blade;
positioning the cover relative to blade; and
applying the braze alloy around the cover.

18. The gas turbine engine method as recited in claim 16, wherein prior to the brazing step the gas turbine engine method includes:
applying an internal coating to an internal cooling passage of the blade;
positioning the cover over at least one opening in a tip shroud of the blade; and
applying the braze alloy around the cover.

19. The gas turbine engine method as recited in claim 16, comprising, prior to the brazing step, positioning the cover at an uneven surface of a tip shroud of the blade and adapting the cover to conform to the uneven surface.

20. The gas turbine engine method as recited in claim 16, wherein the gas turbine engine method is a repair method for repairing a part having a defect.
